(19) United States
(12) Patent Application Publication
(10) Pub. No.: US 2015/0030215 A1
(43) Pub. Date: Jan. 29, 2015

(54) METHOD AND APPARATUS FOR PRODUCING AN IMAGE OF UNDILUTED WHOLE BLOOD SAMPLE HAVING WRIGHT STAIN COLORATION

(71) Applicant: Abbott Point of Care, Inc., Princeton, NJ (US)

(72) Inventors: Niaz L. Khan, New Britain, CT (US); Darryn W. Unfricht, North Haven, CT (US); Robert A. Levine, Guilford, CT (US); Niten V. Lalpuria, Mumbai (IN)

(21) Appl. No.: 14/341,117

(22) Filed: Jul. 25, 2014

Related U.S. Application Data
(60) Provisional application No. 61/858,981, filed on Jul. 26, 2013.

(51) Int. Cl. G06T 7/00

(52) U.S. Cl. CPC G06T 7/0012
USPC 382/120

(57) ABSTRACT

An apparatus and method for imaging a sample of substantially undiluted whole blood is provided. The method includes the steps of: providing a substantially undiluted whole blood sample admixed with at least one non-Wright stain colorant, which colorant is operable to differentially identify constituents containing cytoplasmic material; providing an analysis device having an analyzer with at least one processor, at least one sample illuminator, and at least one image sensor; creating an image of the sample using the analysis device; and using the analysis device to transform the image to a transformed image having a coloration recognizable as a Wright stained sample.

This application claims priority to U.S. Patent Appln. No. 61/858,981 filed Jul. 26, 2013.

### BACKGROUND OF THE INVENTION

1. Technical Field

The present invention relates to apparatus and methods for analysis of whole blood samples in general, and to apparatus and methods for image analysis and image preparation and presentation of unlysed, undiluted whole blood samples in particular.

2. Background Information

Historically, whole blood samples have been analyzed by a trained technician preparing a dyed sample of blood smeared onto a slide, and subsequently examining the smear under a light microscope. A standard method of preparing the smear includes adding Wright's stain to the sample to facilitate the visual differentiation of constituents within the sample by the clinician. Wright's stain, first prepared in 1902 and extensively used since, is a specially prepared mixture of methylene blue and eosin in methanol, used in staining blood smears. Because it is a long standing standard examination technique, Wright stained blood samples are familiar to experienced technicians. Since the introduction of Wright's stain, there have been several other related stains including buffered Wright stain, Wright-Giemsa stain, and buffered Wright-Giemsa stain. For purposes of this disclosure, the terms “Wright's stain” and “Wright stain” are defined to refer to the Wright's stain itself, as well as stains related thereto such as those listed heretofore.

Recently, it has become practically possible to perform automated blood analysis on an undiluted whole sample disposed in an analysis chamber. U.S. Pat. Nos. 6,866,823 and 8,241,572 describe methods and apparatus for imaging an undiluted whole blood sample quiescently residing in a thin layer analysis chamber. Information available from the imaging makes it possible to determine red blood cell indices, cell counts, and more.

A method and apparatus that allows an undiluted whole blood sample to be imaged in an automated analysis system such as those described in the aforesaid patents, and represented in a manner to appear as a Wright stained sample would be helpful to permit a user of the automated system to view the sample in a familiar format.

### SUMMARY OF THE INVENTION

According to an aspect of present disclosure, an apparatus for analyzing a sample of substantially undiluted whole blood disposed in an analysis chamber, which sample is admixed with at least one non-Wright stain colorant, and which colorant is operable to differentially identify constituents containing cytoplasmic material is provided. The apparatus includes at least one sample illuminator, at least one image sensor, and an analyzer. The analyzer includes at least one processor, and is adapted to create an image of the sample using the sample illuminator and the image sensor, and to transform the image to a transformed image having a coloration recognizable as a Wright stained sample.

According to another aspect of the present disclosure, a method for imaging a sample of substantially undiluted whole blood is provided. The method includes the steps of: providing a substantially undiluted whole blood sample admixed with at least one non-Wright stain colorant, which colorant is operable to differentially identify constituents containing cytoplasmic material; providing an analysis device having an analyzer with at least one processor, at least one sample illuminator, and at least one image sensor; creating an image of the sample using the analysis device; and using the analysis device to transform the image to a transformed image having a coloration recognizable as a Wright stained sample.

In a further embodiment of the foregoing aspect, the method further includes the step of displaying the transformed image having a coloration recognizable as a Wright stained sample.

In a further embodiment of any embodiment or aspect above, the step of creating an image includes creating at least one image of the sample using the sample illuminator to produce light at one or more wavelengths that are substantially absorbed by hemoglobin.

In a further embodiment of any embodiment or aspect above, the step of using the analysis device to transform the image includes transforming the first image to a transformed first image that includes at least one image portion representative of a red blood cell, which image portion has coloration recognizable as a Wright stained red blood cell.

In a further embodiment of any embodiment or aspect above, the step of creating an image includes creating at least one image of the sample using the sample illuminator to produce light at one or more wavelengths that are substantially absorbed by the colorant.

In a further embodiment of any embodiment or aspect above, the step of using the analysis device to transform the image includes transforming the second image to a transformed second image that includes at least one image portion representative of a constituent of the whole blood sample containing material stained by the non-Wright stain colorant, which image portion has coloration recognizable as a Wright stained constituent containing material stained by the colorant.

In a further embodiment of any embodiment or aspect above, the step of creating an image includes creating at least one image of the sample using the sample illuminator to produce light at one or more wavelengths that cause the non-Wright stain colorant to emit light.

In a further embodiment of any embodiment or aspect above, the step of using the analysis device to transform the image includes transforming the second image to a transformed second image that includes at least one image portion representative of a constituent of the whole blood sample containing material stained by the non-Wright stain colorant, which image portion has coloration recognizable as a Wright stained constituent containing material stained by the colorant.

In a further embodiment of any embodiment or aspect above, the step of creating an image of the sample using the analysis device includes creating at least one first subset image of the sample using the sample illuminator to produce light at one or more wavelengths that are substantially absorbed within the admixture of sample and non-Wright stain colorant.

In a further embodiment of any embodiment or aspect above, the one or more wavelengths of light that are substantially absorbed within the admixture of sample and non-Wright stain colorant, are wavelengths that are substantially absorbed by hemoglobin within the sample, or are wavelengths that are substantially absorbed by the non-Wright stain colorant within the sample.

In a further embodiment of any embodiment or aspect above, the step of creating at least one first subset image of the sample further includes using the image sensor to sense the light produced by the sample illuminator and produce image signals representative of the sensed light on a per unit basis, and the step of using the analysis device to transform the image includes equating the per unit image signals to per unit Wright stain coloration values.

In a further embodiment of any embodiment or aspect above, the step of creating at least one first subset image of the sample further includes using the image sensor to sense the light produced by the sample illuminator and produce image signals representative of the sensed light on a per unit basis, and masking image units having image signals with a value outside of a predetermined range, wherein the first subset image of the sample includes masked image units and image units with a value within the predetermined range.

In a further embodiment of any embodiment or aspect above, the step of creating an image of the sample includes creating at least one second subset image of the sample using the sample illuminator to produce light at one or more wavelengths that cause the non-Wright stain colorant within the admixture of sample and non-Wright stain colorant to emit light.

In a further embodiment of any embodiment or aspect above, the step of creating at least one second subset image of the sample further includes using the image sensor to sense the light produced by the sample illuminator and produce image signals representative of the sensed light on a per unit basis, and the step of using the analysis device to transform the image includes equating the per unit image signals to per unit Wright stain coloration values.

In a further embodiment of any embodiment or aspect above, the step of using the analysis device to transform the image to a transformed image includes combining the first subset image and the second subset image into a combined image having a coloration recognizable as a Wright stained sample.

In a further embodiment of any embodiment or aspect above, the step of creating at least one second subset image of the sample further includes using the image sensor to sense the light produced by the sample illuminator and produce image signals representative of the sensed light on a per unit basis, and masking image units having image signals with a value outside of a predetermined range, wherein the second subset image of the sample includes masked image units and image units with a value within the predetermined range.

In a further embodiment of any embodiment or aspect above, the step of creating an image of the sample using the analysis device includes creating at least one first subset image of the sample using the sample illuminator to produce light at one or more wavelengths that are substantially absorbed within the admixture of sample and non-Wright stain colorant, and using the image sensor to sense the light produced by the sample illuminator and produce image signals for the first subset image representative of the sensed light on a per unit basis, and includes creating at least one second subset image of the sample using the sample illuminator to produce light at one or more wavelengths that cause the non-Wright stain colorant within the admixture of sample and non-Wright stain colorant to emit light, using the image sensor to sense the light produced by the sample illuminator and produce image signals for the second subset image representative of the sensed light on a per unit basis, and the method further includes the steps of: identifying constituents within the sample using the per unit image signals; masking regions associated with the constituents within the first image subset and the second image subset; and inserting image units transformed to have a coloration recognizable as a Wright stained sample into the masked regions of first image subset and into the second image subset associated with the constituents.

In a further embodiment of any embodiment or aspect above, the step of using the analysis device to transform the image to a transformed image includes combining the first subset image and the second subset image into a combined image having a coloration recognizable as a Wright stained sample.

In a further embodiment of any embodiment or aspect above, the step of creating an image of the sample using the analysis device includes using the image sensor to sense the light produced by the sample illuminator and produce image signals representative of the sensed light on a per unit basis, and the method further includes the steps of: identifying constituents within the sample using the per unit image signals; masking regions associated with the constituents within the image; and inserting image units transformed to have a coloration recognizable as a Wright stained sample into the masked regions of the image associated with the constituents.

In a further embodiment of any embodiment or aspect above, the constituents are selected from the list of white blood cells, red blood cells, platelets, inclusion bodies, and hematoparasites.

The present method and advantages associated therewith will become more readily apparent in view of the detailed description provided below, including the accompanying drawings.

### BRIEF DESCRIPTION OF THE DRAWINGS

FIG. 1 is a diagrammatic perspective view of an analysis cartridge that includes an analysis chamber.

FIG. 2 is an exploded view of the analysis cartridge shown in FIG. 1.

FIG. 3 is a diagrammatic cross-sectional view of the analysis chamber.

FIG. 4 is a diagrammatic view of an analysis device.

FIG. 5 is a schematic diagram of an analyzer embodiment.

### DETAILED DESCRIPTION OF EMBODIMENTS OF THE INVENTION

The present disclosure includes an imaging method which utilizes an undiluted sample of whole blood disposed in a thin layer admixed with a non-Wright stain colorant.

A non-Wright stain colorant is added to a substantially undiluted whole blood sample. As indicated above, the term “Wright stain” is defined to refer to the Wright's stain itself, as well as the related stains including but not limited to buffered Wright stain, Wright-Giemsa stain, and buffered Wright-Giemsa stain. The colorant is operable to differentially identify constituents within the whole blood sample containing cytoplasmic material. The colorant may differentially identify constituents within the sample (e.g., WBCs, platelets, hematoparasites, etc.) by absorbing transmittance light or by emitting fluorescent light in response to one or more excitation wavelengths. Examples of fluorescent non-Wright stain colorants include but are not limited to Acridine Orange (also referred to as “Basic Orange 15” or “ACO”) and Astrazon Orange (also referred to as “AO” or Basic Orange 21). These fluorescent non-Wright stain colorants emit light at particular wavelengths when mixed with whole blood and subjected to an excitation wavelength from a fluorescent light source (e.g., excitation light within the range of about 450-490 nm) Astrazon Orange can also be used as a colorant that can differentially identify constituents within the sample (e.g., WBCs, platelets, hematoparasites, etc.) by absorbing transmittance light.

The thin layer of whole blood may be disposed on a surface such as a slide, or disposed in an analysis chamber that allows the sample to reside in a thin layer. The term “thin layer” is used here to describe a layer of substantially undiluted whole blood having a thickness in the range of about 2-20 microns (2-20μ). A sample layer thin enough to create a monolayer of white blood cells (WBCs) and which has a distribution of red blood cells (RBCs) in a monolayer is advantageous because it facilitates image analysis of the sample. There is no requirement that the sample be fixed. The present method works particularly well with “liquid” samples disposed in an analysis chamber configured to create the aforesaid thin layer of sample.

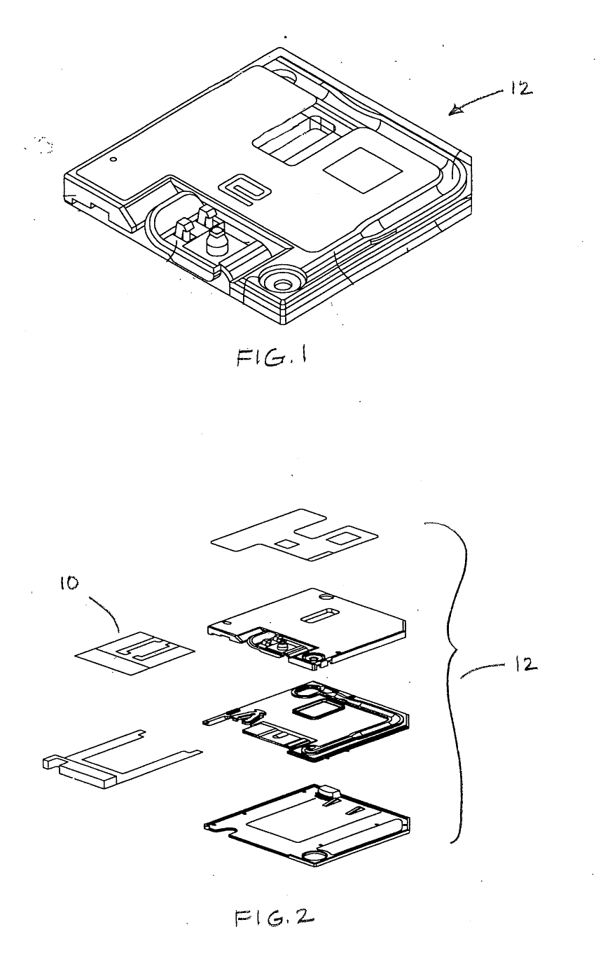

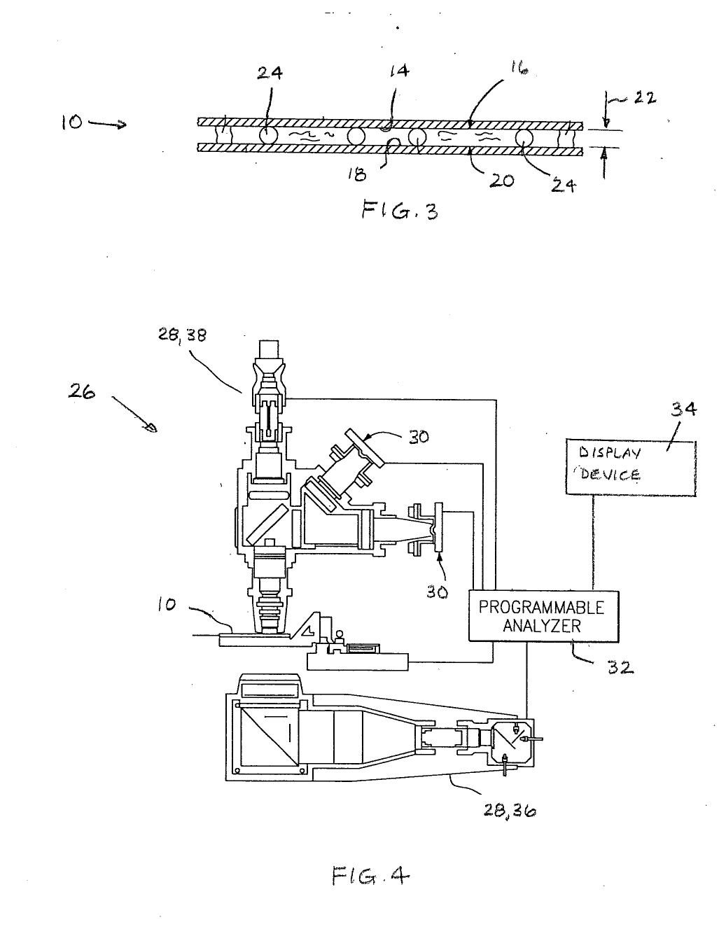

Referring to FIGS. 1-3, in a preferred embodiment the method utilizes an analysis chamber 10 component of an analysis cartridge 12 that is operable to quiescently hold a thin layer sample of unlysed and substantially undiluted whole blood for analysis. The chamber 10 is typically sized to hold about 0.2 to 1.0 microliters (μl) of sample, but the chamber 10 is not limited to any particular volume capacity, and the capacity can vary to suit the analysis application. The phrase “substantially undiluted” as used herein describes a blood sample which is either not diluted at all or has not been diluted purposefully, but has had some reagents added thereto for purposes of the analysis. To the extent the addition of the reagents dilutes the sample, if at all, such dilution has no clinically significant impact on the analysis performed. Typically, the only reagents that will be used in performing the present method are one or more colorants, one or more anti-coagulants (e.g., EDTA, heparin) and in some instances an isovolumetric sphering agent. These reagents are generally added in dried faun and are not intended to dilute the sample. Under certain circumstances (e.g., very rapid analysis), it may not be necessary to add the anti-coagulating agent, but it is preferable to do so in most cases to facilitate analyses of the sample. The term “quiescent” is used to describe that the sample is deposited within the chamber 10 for analysis, and the sample is not purposefully moved relative to the chamber 10 during the analysis; i.e., the sample resides quiescently within the chamber 10. To the extent that motion is present within the blood sample, it will predominantly be due to Brownian motion of the blood sample's formed constituents, which motion is not disabling of the use of the device of this invention.

The preferred analysis chamber 10 is a void defined by an interior surface 14 of a first panel 16, and an interior surface 18 of a second panel 20. The panels 16, 20 are both sufficiently transparent to allow the transmission of light along predetermined wavelengths there through in an amount sufficient to perform an optical density (i.e., light absorption) analysis. Preferably, at least a portion of the panels 16, 20 are parallel with one another, and within that portion the interior surfaces 14, 18 are separated from one another by a height 22. When the sample is disposed in the chamber 10 in sufficient volume, the height 22 of the chamber 10 equals the thickness of the thin layer of the sample. The present method can utilize a variety of different analysis chamber types having the aforesaid characteristics, and is not therefore limited to any particular type of analysis chamber.

The analysis chamber 10 may include a plurality of separators 24 disposed between the panels within the chamber 10. The separators 24 can be any structure that is disposable between the panels 16, 20 operable to space the panels apart from one another. Spherical beads are an example of an acceptable separator 24 and are commercially available from, for example, Bangs Laboratories of Fishers, Ind., U.S.A.

Examples of acceptable analysis chambers, as described above, are described in greater detail in U.S. patent application Ser. Nos. 12/971,860; 13/341,618; and 13/594,439; and U.S. Pat. Nos. 7,903,241; 7,929,122; and 7,951,599, each of which is hereby incorporated by reference in its entirety.

An example of an analysis device 26 that can be adapted for use with the present method is diagrammatically shown in FIG. 4. This specific analysis device 26 is described hereinafter for illustrative purposes, and the present invention is not limited to this particular device. The analysis device 26 includes at least one sample illuminator 28, at least one image sensor 30, an analyzer 32 (e.g., a programmable analyzer), and a display device 34. The display device 34 may be an electronic type display (e.g., an LCD display), or a printer, etc.; i.e., some type of display that allows the end user to visually inspect data produced by the analysis device 26 and images of the sample produced by the analysis device 26.

The sample illuminator 28 includes one or more light sources that selectively produce light at particular wavelengths within a wavelength range broad enough to be useful for the analyses described herein (e.g., wavelengths within the range of about 400-670μ). The sample illuminator 28 can include optics for manipulating the light. The one or more light sources may be in the form of a source of white light, couple with filters that restrict the light reaching the sample to predetermined wavelengths. In preferred embodiments, the light source includes a plurality of light-emitting diodes (LEDs). By their nature, LEDs produce light along a relatively narrow spectral emission profile, with a peak intensity located at a particular wavelength (i.e., the “peak wavelength” of the LED). The imaging analyses provided below can be performed with select different LEDs, each having a different peak wavelength, used to produce different aspects of the sample image.

The sample illuminator 28 can include a first light source that produces light at one or more wavelengths that are substantially absorbed by hemoglobin (e.g., blue light typically in the range of about 405-425 nm), and a second light source that produces light at one or more wavelengths that are substantially absorbed by a colorant, or which cause a colorant to emit light, as will be described below. As indicated above, however, the first light source and the second light source can be accomplished using a white light source and multiple filters.

The embodiment shown in FIG. 4 includes a sample illuminator 28 having a first light source 36 and a second light source 38. The first light source 36 is a transmission light source that produces light at a wavelength of about 413 nm, which wavelength is substantially absorbed by hemoglobin. The second light source 38 is an epi-fluorescence light source that produces light at wavelengths operable to excite light emission from the colorant mixed with the sample. Alternatively, the second light source may take the form of a transmission light source that produces light at a wavelength that is substantially absorbed by the colorant.

The one or more image sensors 30 are disposed to receive light that has passed through the sample (e.g., via transmittance) or light that is emitted from the colorant added to the sample. The image sensor 30 is operable to create signals representative of the light received, which signals are on a per image unit basis, and pass those signals to the analyzer 32 for processing. The term “per unit basis” is used herein to mean an incremental unit of which the image of the sample can be dissected, such as a pixel. The signals from the image sensor 30 provide information (“image signal information”) for each pixel of the image, which information includes, or can be derived to include, intensity and wavelength. Intensity values are assigned an arbitrary scale of, for example, 0 units to 4095 units (“IVUs”). An example of an acceptable image sensor 30 is a charge couple device (CCD) type image sensor that converts the light passing through the sample into an electronic data format. Complementary metal oxide semiconductor (“CMOS”) type image sensors are another example of an image sensor that can be used, and the present invention is not limited to either of these examples.

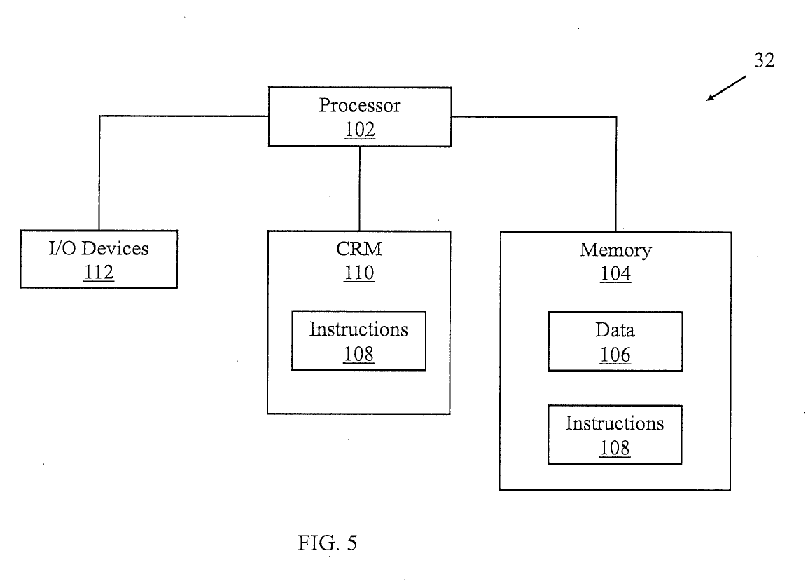

Referring now to FIG. 5 and illustrative example of the analyzer 32 is shown, in communication with the sample illuminator 28 and image sensor 30. The analyzer 32 includes one or more processors (generally shown by a processor 102) and a memory 104. The memory 104 may store data 106 and/or instructions 108. The analyzer 32 may include a computer-readable medium (CRM) 110 that may store some or all of the instructions 108. The CRM 110 may include a transitory and/or non-transitory computer-readable medium. The instructions 108, when executed by the processor 102, may cause the analyzer 32 (or one or more portions thereof) to perform one or more methodological acts or processes, such as those described herein. As an example, execution of the instructions 108 may cause the sample illuminator to subject a sample residing within a chamber to be subjected to light at particular wavelengths of light, and receive image signals from the image sensor, which image signals may be processed to produce an image having one or more sample constituents with a coloration recognizable as a Wright stained constituent. The data 106 may include the image signals on a per unit basis that include, or can be derived to include intensity and wavelength values. The data 106 may also include information that enables the transformation of the image signals into wright stained coloration values, and scaling factors for use therewith. The memory may also store one or more predetermined algorithms for the purpose of evaluating the sample (e.g., WBC count, RBC count, RBC indices, etc.). These are non-limiting examples of the types of data and information that may be stored in the memory 104. The analyzer 32 may include one or more input/output (I/O) devices 112 that may be used to provide an interface between the analyzer 32 and one or more additional systems or entities. The I/O devices 112 may include one or more of a graphical user interface (GUI), a display screen, a touchscreen, a keyboard, a mouse, a joystick, a pushbutton, a microphone, a speaker, a microphone, a transceiver, a sensor, etc. The analyzer 32 described herein is illustrative and non-limiting. In some embodiments, one or more of the components or devices may be optional. In some embodiments, the components/devices may be arranged in a manner that is different from what is shown in FIG. 5. In some embodiments, additional components or devices not shown may be included. For example, the analyzer may include or be connected with one or more networks, one or more switches, routers, and the like. One or more portions of the analyzer 32 may be included in a particular computing device, or in more than one device. Features of the analyzer 32 can be implemented in digital electronic circuitry, or in computer hardware, firmware, or in combinations of them, and the features can be performed by a programmable processor executing a program of instructions to perform functions of the described embodiments by operating on input data and generating output.

The analyzer 32 is adapted to control operation of the light sources 18 and process light signals provided directly or indirectly from the light detectors 19, 20 as described herein. The analyzer 32 is adapted (e.g., programmed) to selectively perform the functions necessary to perform aspects of the present invention, including: 1) perform the instructions of a computer program: 2) perform basic arithmetical and/or logical functions; and 3) perform input/output operations of the analyzer 32, etc. For example, the analyzer 32 is adapted to send signals to, and receive signals from, the sample illuminator 28 and the image sensor 30, selectively perform the functions necessary to operate the sample illuminator 28 and the image sensor 30, and process the signals (e.g., from the image sensor 30) to perform the analyses described herein. A person skilled in the art would be able to adapt (e.g., program) the analyzer 32 to perform the functionality described herein without undue experimentation.

The analyzer 32 is adapted to determine intensity values on a per image unit basis for a region of the sample subjected to a transmittance light source (e.g., first light source 36) based on the signals from the image sensor 30. As indicated above, the intensity values may be assigned an arbitrary scale of, for example, 0 units to 4095 units (“IVUs”). The transmittance intensity values are sometimes quantified in terms of optical density (“OD”), which is actually the converse of the intensity of the light received by the image sensor 30 in a transmittance measurement. Optical density (“OD”) is a characteristic of a medium (i.e., a quantitative value) relating to the propensity of light to be absorbed as it passes through a medium; e.g., the higher the “OD” value, the greater the amount of light absorbed during transmission. The terra “substantially absorbed” as used herein in the context of light absorption refers to absorption of the wavelengths of light in an amount that is useful for producing images as described herein. Hemoglobin, for example, has a high molar extinction coefficient at about 413 nm relative to light at other wavelengths; e.g., light at 413 nm is substantially absorbed by hemoglobin. The determined OD of RBCs within the sample is a function of the hemoglobin concentration within the RBCs, the molar extinction coefficient (also referred to as molar absorptivity) for hemoglobin at a given wavelength, and the distance of the light path traveled through the hemoglobin, which relationship can be mathematically represented as follows:

OD=εcL

where ε=hemoglobin molar extinction coefficient, c=hemoglobin concentration, and L=distance traveled through the hemoglobin within the sample between the panel interior surfaces. The molar extinction coefficient is an intrinsic property of the hemoglobin that can be derived by experimentation, or through empirical data currently available. In those embodiments that use a light absorbing colorant to stain material within a constituent within the whole blood sample (e.g., a WBC, platelet, hematoparasite, etc), the determined OD value is a function of the colorant concentration within the constituent (or within an element of the constituent).

The analyzer 32 may be further adapted to determine intensity values for light fluorescently emitted from colorant disposed within the sample (e.g., colorant residing within WBCs or platelets) on a per image unit basis for a region of the sample subjected to an excitation light source (e.g., second light source 38), which determination is based on the signals from the image sensor 30. Here again, the intensity values may be assigned an arbitrary scale of, for example, 0 units to 4095 units (“IVUs”). The per image unit intensity values are a function of the colorant concentration within the respective sample image portion, and the amount of cytoplasmic material within the constituent.

The signals from the image sensor 30, or information relating to the signals, may be separated into multiple channels for processing by the analyzer 32. For example, the signals may be separated into three channels. A first of the three channels may be directed toward signals relating to light emitted from the sample at a first wavelength (e.g., 540 nm, which appears green), which emitted light results from the sample being subjected to light at an excitation wavelength. A second channel may be directed toward signals relating to light emitted from the sample at a second wavelength (e.g., 660 nm, which appears red), which emitted light also results from the sample being subjected to the excitation wavelength. When the Acridine Orange (“ACO”) is used as the colorant to be admixed with the whole blood sample and the sample is subjected to excitation light at about 470 nm, the ACO bound to materials (e.g., DNA) within the nucleus of a white blood cell will emit light at about 540 nm (which appears green), and the ACO bound to materials (e.g., RNA) within the cytoplasm of a white blood cell will emit light at about 660 nm (which appears red). A third channel may be directed toward signals relating to light passing through the sample at a third wavelength (e.g., 413 nm, which is used to determine blue optical density—“OD”).

The present invention is not limited to these particular wavelengths or number of channels. Additional channels can be implemented to gather information at different wavelengths and/or transmission values. That information, in turn, can be used to evaluate additional constituents (i.e., platelets, reticulocytes, inclusion bodies, etc.) within the sample and/or to increase the accuracy of the analysis.

The programmable analyzer 32 is further adapted to process the signals received from the image sensor 30 according to one or more predetermined algorithms for the purpose of evaluating the sample (e.g., WBC count, RBC count, RBC indices, etc.). The specifics of a particular algorithm will depend upon the analysis at hand and the analyzer 32 is not limited to any particular algorithm. Examples of methodologies/algorithms with which the analyzer 32 may be adapted include those described in U.S. patent application Ser. No. 13/204,425 directed toward identifying at least one type of WBC within a whole blood sample, and U.S. patent application Ser. No. 13/730,095 directed toward identifying platelets within a whole blood sample, both of which applications are hereby incorporated by reference into the present application in their entirety.

In addition, the analyzer 32 is further adapted to selectively use (e.g., upon command by the user) the signals in each channel to create an image of the whole blood sample being analyzed in a manner that the sample constituents appear to be subject to Wright's stain. This image may be produced on an electronic display device (e.g., LCD), a printed page via a printer, or any other display device that allows the analysis device user to view the whole blood sample as though it had been stained by Wright's stain. As indicated above, the use of Wright's stain to differentiate constituents within a whole blood sample is well known, and consequently an accurate representation of a whole blood sample using coloration associated with Wright's stain greatly facilitates visual sample analysis by the user. This visual representation can be used by a clinician to verify automated results otherwise provided by the analysis device 26, or for the purpose of further analysis of the imaged sample. In addition, the analyzer is adapted to produce images of segregated constituents from the whole blood sample being analyzed in a manner that the sample constituents appear to be subject to Wright's stain; e.g. an image of the only the WBCs, or only the RBCs, etc. within the sample with a Wright's stain appearance.

To create an image of the whole blood sample being analyzed in a manner that the sample constituents appear to be subject to Wright's stain, the analyzer 32 is adapted to transform the signals within the respective channels described above in a manner that allows the sample image to appear in Wright's stain coloration. In a sample conventionally stained with Wright's stain, RBCs appear to have a purplish-red coloration, nuclei within WBCs appear to have a dark purple coloration, and cytoplasm appears to have a light purple coloration. Plasma within the sample appears as a light pink background. The transformation enables the constituents within the sample to be visualized having these conventional Wright's stain coloration. The transformation process is not limited to WBCs generically and RBCs, however. Specific WBC types (e.g., eosinophils), reticulocytes, inclusion bodies, and platelets, for example, have distinctive Wright stain colorations. The transformation process as described below can be applied to these constituents, and others, as well.

In a first example, the transformation process includes acquiring the image signal information as described above for each of the channels. This process may be referred to as part of creating a subset image of the sample using the sample illuminator. Regarding RBCs, an optical density image of the sample can be taken with a transmittance light source that produces light at a wavelength that is absorbed by hemoglobin (e.g., about 413 nm). As described above, the optical density image may be characterized on a per image unit basis (i.e., per pixel). Each pixel therefore has an intensity value associated with the wavelength at which it was acquired. The analyzer 32 is adapted to equate the per image unit OD intensity values to corresponding per image unit Wright stain coloration intensity values. A scaling factor can be used, for example, so that higher OD intensity values appear having darker purplish-red coloration, and lower OD intensity values appear having lighter purplish-red coloration. Threshold limits can be applied to each end of the scale so that OD intensity values below a predetermined value and above a predetermined value are filtered out. The specific coloration and scaling can be adjusted to provide the most accurate Wright stain representation of the RBCs.

A similar methodology is applied to add Wright's stain coloration to constituents within the sample whole blood sample that contain material stained by the non-Wright stain colorant. For example, if a fluorescent colorant such as Acridine Orange is used to tag WBCs, the sample is subject to an excitation light source (e.g., 470 nm) and fluorescently emitted light at a wavelength associated with nuclear material (which contains DNA) is captured by the image sensor 30 in a second channel. As indicated above, light at this emitted wavelength is produced as a function of the colorant combining with the nuclear material within the WBC. The intensity of the emitted light is characterized on a per image unit basis (i.e., per pixel) by the analyzer 32 using the images from the image sensor 30. Each pixel therefore has an intensity value associated with that emitted wavelength. The analyzer 32 is adapted to equate the per image unit emitted light intensity values to corresponding per image unit Wright stain coloration intensity values for nuclear material, which have a dark purple coloration. A scaling factor can be used, for example, so that higher emitted light intensity values appear having a greater dark purple coloration, and lower emitted light intensity values appear having a lesser dark purple coloration. Threshold limits can be applied to each end of the scale so that emitted intensity values below a predetermined value and above a predetermined value are filtered out. The specific coloration and scaling can be adjusted to provide the most accurate Wright stain representation of the WBC nuclei.

The same excitation light source (e.g., 470 nm) can be used to produce fluorescently emitted light at a second wavelength which is associated with WBC cytoplasm (which contains RNA), which is then captured by the image sensor 30 in a third channel. The intensity of the emitted light is characterized on a per image unit basis (i.e., per pixel) by the analyzer 32 using the images from the image sensor 30. Each pixel therefore has an intensity value associated with that emitted wavelength. The analyzer 32 is adapted to equate the per image unit emitted light intensity values to corresponding per image unit Wright stain coloration intensity values for WBC cytoplasm, which has a light purple coloration. A scaling factor can be used, for example, so that higher emitted light intensity values appear having a greater light purple coloration, and lower emitted light intensity values appear having a lesser light purple coloration. Threshold limits can be applied to each end of the scale so that emitted intensity values below a predetermined value and above a predetermined value are filtered out. The specific coloration and scaling can be adjusted to provide the most accurate Wright stain representation of the WBC cytoplasm.

In each of these channels, the scaling factors equating the per image unit intensity values to Wright stain intensity unit values can be a linear transformation, or it can be a non-linear transformation; e.g., a non-linear scaling factor that may, for example, be logarithmic. In some embodiments, a non-linear transformation can be used to accentuate constituent elements for improved visualization. For example, a non-linear transformation can be used for one or both of the image units attributable to WBC nuclear material and WBC cytoplasm to accentuate the relative colorations and thereby improve visualization and/or increase the accuracy of the Wright stain representation.

Once each channel of the image is transformed, the separate image channels (e.g., image subset) can be combined to produce a collective Wright stain representation of the imaged sample. Several methods of combining the channels can be used, and the present methods of producing a Wright stain image are not limited to any particular method of combining. For example, one method for combining the image channels involves masking techniques. In some instances, the masking process may evaluate the image signals within a given image channel (e.g., image subset) relative to a threshold or relative to a predetermined range of values. Image signals below or above a threshold or inside or outside of a predetermined range of values may be masked. There are a variety of different known masking techniques and the present disclosure is not limited to using any particular masking technique. The per image units associated with the WBC nuclei regions and the WBC cytoplasm regions are identified and masked, and the transformed Wright stain colorations are combined in the masked areas to create the transformed Wright stain WBCs. The transformed Wright stain WBCs are subsequently combined with the transformed Wright stained RBCs to create the collective transformed Wright stained sample image. The specific order of masking and adding the transformed components of the collective image is not limited to any particular order.

According to another method for combining the image channels includes manipulating the relative intensity values of the channels relative to one another; e.g., multiplying the relative intensity values of the per image units associated with the nuclei by per image intensity values associated with the cytoplasm region. The per image unit intensity values for the cytoplasm and nuclei regions for a given WBC are then combined to create the transformed Wright stain WBCs. The transformed Wright stain WBCs are subsequently combined with the transformed Wright stained RBCs to create the collective transformed Wright stained sample image. This method is not limited to manipulation by multiplication; i.e., other intensity value manipulations may be used alternatively.

As indicated above, the transformation processes described above are not limited to WBCs generically and RBCs, and may be used to transform other constituents (e.g., specific WBCs like eosinophils which have a slightly different Wright stain coloration than other WBCs, reticulocytes, inclusion bodies, platelets, etc.) within the whole blood sample. With respect to platelets, the transformation process can be performed on the entire sample image used above for WBCs and RBCs. Alternatively, in view of the substantially larger number of platelets present in the sample, the transformation process can be performed on a percentage of the sample image (e.g., a center quartile) and the same region of the sample can then be combined to arrive at the collective transformed Wright stained sample image.

Although this invention has been shown and described with respect to the detailed embodiments thereof, it will be understood by those skilled in the art that various changes in form and detail may be made without departing from the spirit and scope of the invention.

What is claimed:

1. A method for imaging a sample of substantially undiluted whole blood, comprising the steps of:
providing a substantially undiluted whole blood sample admixed with at least one non-Wright stain colorant, which colorant is operable to differentially identify constituents containing cytoplasmic material;
providing an analysis device having an analyzer with at least one processor, at least one sample illuminator, and at least one image sensor;
creating an image of the sample using the analysis device; and
using the analysis device to transform the image to a transformed image having a coloration recognizable as a Wright stained sample.

2. The method of claim 1, further comprising the step of displaying the transformed image having a coloration recognizable as a Wright stained sample.

3. The method of claim 1, wherein the step of creating an image includes creating at least one image of the sample using the sample illuminator to produce light at one or more wavelengths that are substantially absorbed by hemoglobin.

4. The method of claim 3, wherein the step of using the analysis device to transform the image includes transforming the first image to a transformed first image that includes at least one image portion representative of a red blood cell, which image portion has coloration recognizable as a Wright stained red blood cell.

5. The method of claim 1, wherein the step of creating an image includes creating at least one image of the sample using the sample illuminator to produce light at one or more wavelengths that are substantially absorbed by the colorant.

6. The method of claim 5, wherein the step of using the analysis device to transform the image includes transforming the second image to a transformed second image that includes at least one image portion representative of a constituent of the whole blood sample containing material stained by the non-Wright stain colorant, which image portion has coloration recognizable as a Wright stained constituent containing material stained by the colorant.

7. The method of claim 1, wherein the step of creating an image includes creating at least one image of the sample using the sample illuminator to produce light at one or more wavelengths that cause the non-Wright stain colorant to emit light.

8. The method of claim 7, wherein the step of using the analysis device to transform the image includes transforming the second image to a transformed second image that includes at least one image portion representative of a constituent of the whole blood sample containing material stained by the non-Wright stain colorant, which image portion has coloration recognizable as a Wright stained constituent containing material stained by the colorant.

9. The method of claim 1, wherein the step of creating an image of the sample using the analysis device includes creating at least one first subset image of the sample using the sample illuminator to produce light at one or more wavelengths that are substantially absorbed within the admixture of sample and non-Wright stain colorant.

10. The method of claim 9, wherein the one or more wavelengths of light that are substantially absorbed within the admixture of sample and non-Wright stain colorant are wavelengths that are substantially absorbed by hemoglobin within the sample, or are wavelengths that are substantially absorbed by the non-Wright stain colorant within the sample.

11. The method of claim 10, wherein the step of creating at least one first subset image of the sample further includes using the image sensor to sense the light produced by the sample illuminator and produce image signals representative of the sensed light on a per unit basis, and the step of using the analysis device to transform the image includes equating the per unit image signals to per unit Wright stain coloration values.

12. The method of claim 10, wherein the step of creating at least one first subset image of the sample further includes using the image sensor to sense the light produced by the sample illuminator and produce image signals representative of the sensed light on a per unit basis and masked image units, wherein the first subset image of the sample includes masked image units and image units with a value within the predetermined range.

13. The method of claim 11, wherein the step of creating an image of the sample includes creating at least one second subset image of the sample using the sample illuminator to produce light at one or more wavelengths that cause the non-Wright stain colorant within the admixture of sample and non-Wright stain colorant to emit light.

14. The method of claim 13, wherein the step of creating at least one second subset image of the sample further includes using the image sensor to sense the light emitted from the non-Wright stain colorant and produce image signals representative of the sensed light on a per unit basis, and the step of using the analysis device to transform the image includes equating the per unit image signals to per unit Wright stain coloration values.

15. The method of claim 14, wherein the step of using the analysis device to transform the image to a transformed image includes combining the first subset image and the second subset image into a combined image having a coloration recognizable as a Wright stained sample.

16. The method of claim 13, wherein the step of creating at least one second subset image of the sample further includes using the image sensor to sense the light emitted from the non-Wright stain colorant and produce image signals representative of the sensed light on a per unit basis, and masked image units, wherein the second subset image of the sample includes masked image units and image units with a value within the predetermined range.

17. The method of claim 1, wherein the step of creating an image of the sample using the analysis device includes creating at least one first subset image of the sample using the sample illuminator to produce light at one or more wavelengths that are substantially absorbed within the admixture of sample and non-Wright stain colorant, and using the image sensor to sense the light produced by the sample illuminator and produce image signals for the first subset image representative of the sensed light on a per unit basis, and includes creating at least one second subset image of the sample using the sample illuminator to produce light at one or more wavelengths that cause the non-Wright stain colorant within the admixture of sample and non-Wright stain colorant to emit light, using the image sensor to sense the light emitted from the non-Wright stain colorant and produce image signals for the second subset image representative of the sensed light on a per unit basis, and the method further includes the steps of:
identifying constituents within the sample using the per unit image signals;
masking regions associated with the constituents within the first image subset and the second image subset; and
inserting image units transformed to have a coloration recognizable as a Wright stained sample into the masked regions of first image subset and into the second image subset associated with the constituents.

18. The method of claim 17, wherein the step of using the analysis device to transform the image to a transformed image includes combining the first subset image and the second subset image into a combined image having a coloration recognizable as a Wright stained sample.

19. The method of claim 1, wherein the step of creating an image of the sample using the analysis device includes using the image sensor to sense one or both of the light produced by the sample illuminator and light emitted from the non-Wright stain colorant, and produce image signals representative of the sensed light on a per unit basis, and the method further includes the steps of:
identifying constituents within the sample using the per unit image signals;
masking regions associated with the constituents within the image; and
inserting image units transformed to have a coloration recognizable as a Wright stained sample into the masked regions of the image associated with the constituents.

20. The method of claim 19, wherein the constituents are selected from the list of white blood cells, red blood cells, platelets, inclusion bodies, and hematoparasites.

21. An apparatus for analyzing a sample of substantially undiluted whole blood disposed in an analysis chamber, which sample is admixed with at least one non-Wright stain colorant, which colorant is operable to differentially identify constituents containing cytoplasmic material, the apparatus comprising:
at least one sample illuminator;
at least one image sensor; and
an analyzer with at least one processor, which analyzer is adapted to create an image of the sample using the sample illuminator and the image sensor, and adapted to transform the image to a transformed image having a coloration recognizable as a Wright stained sample.
